(19) United States
(12) Patent Application Publication
(10) Pub. No.: US 2013/0236192 A1
(43) Pub. Date: Sep. 12, 2013

(54) PORTABLE ELECTRONIC DEVICE, EXTERNAL BASIC DEVICE, METHOD FOR COUPLING THE PORTABLE ELECTRONIC DEVICE TO AN EXTERNAL BASIC DEVICE AND USING THE EXTERNAL BASIC DEVICE FOR COUPLING THE PORTABLE ELECTRONIC DEVICE

(71) Applicant: Fraunhofer-Gesellschaft zur Foerderung der Angewandten Forschung e.V., (US)

(72) Inventors: Frank DEICKE, Dresden (DE); Hagen GRAETZ, Grossweitzschen (DE)

(73) Assignee: Fraunhofer-Gesellschaft zur foerderung der angewandten Forschung e. V., Munechen (DE)

(21) Appl. No.: 13/870,730

(22) Filed: Apr. 25, 2013

Related U.S. Application Data
(63) Continuation of application No. PCT/EP2011/067910, filed on Oct. 13, 2011.

(30) Foreign Application Priority Data
Oct. 29, 2010 (DE) 102010043154.0

(51) Int. Cl. H04B 10/50

(52) U.S. Cl. CPC H04B 10/50
USPC 398/135

(57) ABSTRACT

A portable electronic device includes a functional processor for providing an electronic functionality, an optical data transmitter for conductor-less, optical data communication with an external basic device and an energy supplier for an energy absorption by means of an inductive coupling from a magnetic field emitted by the external basic device and for supplying the functional processor and the data transmitter with energy based on the energy absorbed from the external magnetic field.

### CROSS-REFERENCE TO RELATED APPLICATIONS

This application is a continuation of copending International Application No. PCT/EP2011/067910, filed Oct. 13, 2011, which is incorporated herein by reference in its entirety, and additionally claims priority from German Application No. DE 102010043154.0, filed Oct. 29, 2010, which is also incorporated herein by reference in its entirety.

### BACKGROUND OF THE INVENTION

The present invention relates to a portable electronic device, an external basic device (e.g., a docking station), a method for coupling the portable electronic device to an external basic device and the use of the external basic device for energy and data coupling to the portable device, and in particular to portable electronic devices of the consumer area, medical technology or industrial technology and associated external basic devices, like e.g. base stations or docking stations for a conductor-less (wireless) energy and data transmission. The present invention thus in particular relates to providing an interface for plugless, portable electronic terminal devices and associated base stations for coupling these portable terminal devices for a wireless (conductor-less) energy and data transmission between the base station and the portable electronic terminal device.

In many fields of application of data communication, portable electronic terminal devices are used today. For example, devices for the consumer area, e.g., mobile telephones, tablet PCs, E-Readers, cameras, notebooks, etc., for medical technology, e.g., telemonitoring systems or for industry, e.g., industrial cameras etc. Apart from providing the portable applications and services of the portable electronic devices, charging the battery, data comparison with respect to a base station or a peripheral device connected to the same, saving data and the connection of external peripheral devices, e.g., via a docking station in case of a notebook as a portable electronic device are indispensable for operating same.

For a connection and energy supply of portable electronic terminal devices via an interface, up to now mainly plug-based solutions have been used which only provide a limited performance or efficiency in the field of user-friendliness, long-term stability or reliability, wherein these deficiencies occur in particular with a data transfer with data rates as high as possible. A criterion limiting the performance is here, in particular, the frequently non-preventable wear of plug contacts which may, in particular, be a problem with high data rates and the conventionally low degree of protection of devices, as it for example becomes obvious according to the protection class according to DIN EN 60529 for the protection of devices from the entry of dust and water.

With known RF based approaches for a wireless coupling of portable electronic terminal devices in a local radio network to a docking station, however, only relatively low gross data rates are acquired with a relatively low efficiency (of approximately 20 to 50%), so that only relatively low net data rates between the portable terminal device and the base station or a peripheral device connected to the base station may be realized.

### SUMMARY

According to an embodiment, a portable electronic device may have a functional processor for providing an electronic functionality; an optical data transmitter for a conductor-less, optical data communication with an external basic device, wherein the optical data transmitter comprises a plurality of optical interface elements for establishing a conductor-less, optical data transmission with the external basic device, and wherein a communication controller is associated with the optical data transmitter, wherein the communication controller is implemented to selectively allocate the data communication with an external basic device associated with an electronic functionality of the functional processor each to an optical interface element of the plurality of optical interface elements; and an energy supplier for energy absorption by means of an inductive coupling from a magnetic field emitted from the external basic device and for supplying the functional processor and the data transmitter with energy based on the energy taken from the external magnetic field.

According to another embodiment, a basic device for energy and data transmission to a portable electronic device may have an energy provider for generating a magnetic field for an energy supply of the portable electronic device by means of an inductive coupling from the generated magnetic field; and an optical, bidirectional data communicator for a conductor-less, optical data communication with the portable electronic device; wherein the optical, bidirectional data communicator comprises a plurality of optical interface elements for establishing a conductor-less, bidirectional, optical data communication with the portable electronic device, and wherein a communication controller is associated with the optical data communicator, wherein the communication controller is implemented to selectively allocate the data communication with the portable electronic device associated with an electronic functionality of the portable electronic device each to an optical interface element of the plurality of optical interface elements.

According to another embodiment, a portable data storage in the form of an external hard disk or a memory stick with a conductor-less energy supply and data communication may have a functional processor with a non-volatile memory element for providing an electronic functionality in the form of storing data and providing stored data upon request; an optical, bidirectional data transmitter for a conductor-less, optical data communication with an external basic device; and an energy supplier for energy absorption by means of an inductive coupling from a magnetic field emitted by the external basic device and for supplying the functional processor and the data transmitter with energy based on the energy taken from the external magnetic field; wherein the energy supplier comprises a chargeable charge storage element and is further implemented to charge the chargeable charge storage element based on the energy taken from the external magnetic field.

According to another embodiment, a method for coupling a portable electronic device to an external basic device, wherein the optical data transmitter comprises a functional processor for providing a plurality of electronic functionalities and further a plurality of optical interface elements for establishing a conductor-less, optical data transmission with the external basic device, may have the steps of determining a portable electronic device which is present in a coupling area of the external basic device; establishing a conductor-less energy and data transmission between the portable electronic device and the external basic device; and selectively allocating the data communication with the external basic device associated with an electronic functionality of the functional processor each to an optical interface element of the plurality of optical interface elements.

The basic idea of the present invention is to implement a portable electronic terminal device with an optical data transmission means for conductor-less (conductor or wave guide-less), optical, bidirectional data communication with an external basic device and in addition to this, with a conductor-less energy supply means for energy absorption by means of an inductive coupling from a magnetic field emitted by the external basic device and for supplying the implemented functional units and the data transmission means with energy based on the energy taken from the external magnetic field.

An associated, external basic device for energy and data transmission to a coupled, portable electronic device according to the invention comprises a conductor-less energy provisioning means for generating the magnetic field for an energy supply of the portable electronic device by means of an inductive coupling from the generated magnetic field and further an optical data communicator for a conductor-less, optical, bidirectional data communication with the portable electronic device.

According to the invention, thus between the portable electronic device and the external basic device, like e.g. a base station or a so-called docking station, a conductor-less energy and data transmission to the portable electronic terminal device may be executed.

The external basic device is thus, for example, implemented to charge the rechargeable battery of a portable device, e.g., a consumer terminal device, and exchange data bidirectionally with the portable electronic terminal device. The portable electronic terminal device is additionally supplied with energy in the external basic device, so that the applications and services which are to be executed on or by the portable electronic terminal device are still available during the charging process. According to the invention, the energy transmission from the external basic device to the portable electronic device is based on the principle of inductive coupling (analog to loosely coupled transformers), wherein based on the special antenna arrangements and circuit concepts to be described in the following, for example with frequencies from 10 KHz to 20 KHz, power up to, for example, the two digit Watt range is provided by the external basic device and may be received by the portable electronic terminal device.

Further, the wireless data transmission by means of optical, bidirectional conductor-less communication arrangements is implemented, which provides very high data transmission rates up to the GBit/s range. A special advantage of the optical, bidirectional conductor-less data communication between the portable electronic device and the external basic device are a very secure data connection with respect to data protection aspects and independence and immunity to interference with respect to electromagnetic interference sources, so that a high electromagnetic compatibility “EMC” exists, i.e., basically a lack of interference of the portable electronic device with respect to its environment. It is further to be noted that a basically worldwide usability of the inventive concept is guaranteed, as with respect to an optical data communication no regulation of frequency range and bandwidth exists by national authorities like the Federal Network Agency (Bundesnetzagentur).

According to the invention, the optical data transmission is based on a visual connection or line of sight. By this, in a relatively simple way very secure data connections may be provided between the portable electronic device and the external basic device. It is additionally possible compared to RF based approaches to each utilize the full bandwidth in several pico-cells arranged in parallel, i.e., in several parallel optical transmission elements. Thus, according to the invention, in a parallel operation of several data channels in a portable electronic device and the coupled external basic device (for example, in a half duplex or full duplex mode) data rates of several GBit/s may be acquired so that data rates in the range of glass fiber networks may be realized. Thus, in particular, an optical data transmission may be utilized very effectively in the infrared range, e.g., with wavelengths from 850 to 900 nm, as the sensitivity of currently available receiver diodes for this wavelength range is very high and in addition to this noise, i.e., interferences of the surroundings as compared to visible light, is very low. Of course, however, all technically possible wavelengths may be utilized for an optical data transmission, among others also in the visible wavelength range.

As now, according to the invention, no externally accessible plug contacts which are subject to mechanical wear are needed in the inventive concept for a portable electronic device and an associated external basic device, very robust, dust and water tight portable terminal devices may be manufactured without additionally necessitated interfaces and simultaneously their reliability and user-friendliness may be increased. Thus, in addition to this, further possibilities of application of the inventive concept exist for example in medical technology. Thus, telemonitoring systems, i.e. systems for monitoring medical or physiological data of a patient, may be set up based on the inventive portable electronic device and its associated external basic device, wherein the portable electronic device in the form of the telemonitoring terminal device may be completely hermetically encapsulated against environmental influences due to the fact that no electrically and mechanically accessible interfaces are needed. Thus, such a portable medical terminal device may for example be implemented to be easily disinfected, robust and easy to clean. For example, such telemonitoring devices may additionally be integrated into washable clothing of the person to be examined with a simplified cost-effective maintenance.

In other fields of application, like e.g. industrial cameras or in the consumer area in case of portable, multimedia-capable terminal devices like e.g. mobile telephones, tablet PCs, E-Readers, etc. using the inventive approach simple, smaller, lighter and more cost-effective housings may be used for the portable devices which apart from that simultaneously provide a higher degree of protection for the portable device and thus may also be subjected to harsh environmental influences with an improved user-friendliness and reliability. Apart from that, based on the inventive conductor-less energy and data transmission concept, for example notebooks, tablet PCs, E-Readers, mobile telephones, etc. may be setup even flatter than it is possible, for example, with conventional devices today.

A further main issue of the present invention is to acquire a portable conductor- or plug-less data storage, like e.g. a plugless memory stick using the inventive concept which may replace today's USB sticks, SD cards and portable discs or SSDs (SSD=Solid State Disks). These portable data storages which are for example also battery-less are wirelessly supplied with energy during the wireless (optical) data transmission for the read/write operation via the optical communication interface by the read/write station, i.e. the external basic device which is for example implemented as a computer, camera, multi-media kiosk or is connected to such a device as a peripheral device via an interface. The main advantage of this inventive process compared to currently available solutions for data storages is, apart from the high robustness of such a portable data storage, in particular also a very high acquirable data rate and thus an extremely fast data transfer between the portable data storage and the associated or coupled external basic device or a further peripheral device.

The inventive concept for a portable electronic device and an associated external basic device implemented by means of a conductor-less energy and data transmission may in particular be used with different fields of applications which have different requirements with respect to energy transmission, i.e. with respect to power input of the portable electronic device and the data rate for data communication as well as with respect to associated metrics like efficiency, form factor, weight, stability, user-friendliness or reliability.

### BRIEF DESCRIPTION OF THE DRAWINGS

Embodiments of the present invention will be detailed subsequently referring to the appended drawings, in which:

FIG. 1a-b is a schematic diagram of a portable electronic device and an external basic device according to an embodiment of the present invention;

FIG. 2a-b is a schematic diagram of a portable electronic device with associated functional units according to a further embodiment of the present invention;

FIG. 3a-c is a schematic diagram of a portable data storage with associated functional units according to a further embodiment of the present invention;

FIG. 4a-c are schematic diagrams of an external basic device with associated functional units according to a further embodiment of the present invention;

FIG. 5a-b is a schematic diagram of alternative embodiments of the arrangements for a conductor-less energy and data transmission of the portable electronic device and the external basic device according to further embodiments of the present invention;

FIG. 6 a schematic diagram of an alternative implementation of the portable electronic device according to a further embodiment of the present invention; and

FIG. 7 is a method for coupling the portable electronic device to an external basic device according to a further embodiment of the present invention.

### DETAILED DESCRIPTION OF THE INVENTION

Before the present invention is explained in more detail with reference to the drawings in the following, it is noted that identical, functionally like or seemingly like elements in the figures are provided with the same reference numerals, so that the description of those elements represented in the different embodiments is mutually interchangeable or mutually applicable.

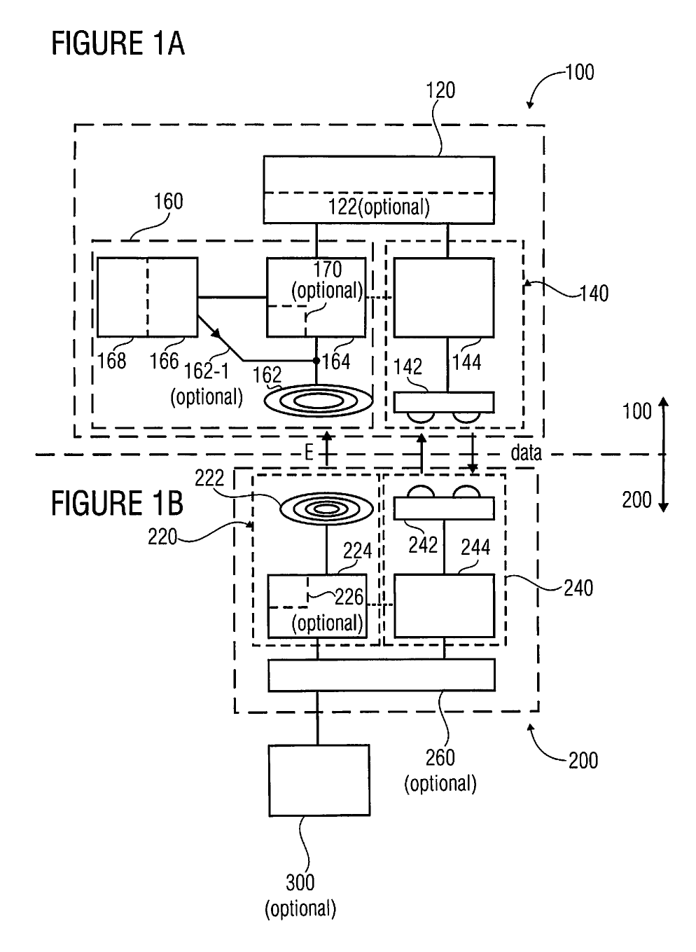

In the following, with reference to FIG. 1a-b, a first embodiment for a portable electronic device 100 and further for an external basic device 200 is explained according to embodiments of the present invention.

FIG. 1a shows the portable electronic device 100 with a functional means 120 for providing an electronic functionality, an optical, bidirectional data transmission means 140 for a conductor-less optical data communication with the external basic device 200 and an energy supply means 160 for an energy absorption by means of an inductive coupling from a magnetic field emitted by the external basic device 200 and for supplying the functional means 120 and the data transmission means 140 with energy based on the energy E taken from the external magnetic field.

FIG. 1b shows a schematic diagram of an inventive basic device 200 for a conductor-less energy and data transmission to the portable electronic device 100 according to an embodiment of the present invention. The external basic device 200 comprises an energy provisioning means 220 for generating a magnetic field for an energy supply of the portable electronic device 100 and further an optical, bidirectional data communication means 240 for a conductor-less optical, bidirectional data communication with the portable electronic device 100.

In FIG. 1b, further a peripheral device 300 is illustrated optionally connected to the external basic device, wherein the peripheral device for example has a data connection to the portable electronic device 100 via the external basic device 200. The external basic device 200 may further optionally comprise an I/O interface or a (higher level) control means 260 for a logical connection of peripheral devices 300 to the portable electronic device 100. Alternatively, also the basic device 200 itself may comprise the function of a peripheral device (e.g. a PC, notebook, etc) having corresponding user interfaces for inputting user instructions.

In the following, first of all possible implementations of the portable electronic device 100 and the functional units contained therein are discussed. In this context it is noted that the portable electronic device 100 may for example be a portable, multimedia-capable terminal device, like e.g. a mobile telephone, a notebook, a tablet PC, an E-Reader or a digital camera, wherein the functional means 120 is now implemented to execute an application or a service of the portable multimedia-capable terminal device 100 as an electronic functionality. Likewise, the portable electronic device may be implemented as a portable data storage, wherein the functional means 120 then comprises a non-volatile mass storage to store data as its electronic functionality and provide the same again upon request. Apart from that, the portable electronic device may for example also be implemented as a so-called telemonitoring device for a supervision of persons or patients, wherein the functional means 120 may then be implemented to detect, as an electrical or electronic functionality, medical or physiological data of persons or patients and possibly also environmental data with respect to the surrounding atmosphere and to evaluate the detected data or to provide the detected data to the external basic device 200 or to the peripheral device 300 connected thereto via an interface for rendering and for evaluation. Generally speaking, the portable electronic device 100 relates to any portable electronic devices which are to be connectable or coupleable to an external basic device 200 for energy supply and data exchange.

In the following now, one after the other, the individual assemblies of the inventive portable electronic device 100 and the external basic device 200 (according to their allocation with respect to each other) are described.

The energy supply means 160 of the portable electronic device 100 now comprises an antenna arrangement 162 for example in the form of a coil or coil antenna having a number of n windings with or without a coil core, to have necessitated energy E provided by the energy transmission means 220 of the external basic device 200 by means of inductive coupling according to the principle of a loosely coupled transformer.

As a counter-induction or inductive coupling the mutual magnetic influencing of two or more spatially adjacent electrical circuits, i.e. the antenna arrangement 162 and 222 of the portable electronic device 100 for example implemented as coils and the external basic device 200 are designated by the mathematic flux Φ.

For increasing the inductive coupling between the two antenna arrangements 162 and 222 of the portable electronic device 100 and the external basic device 200 the antenna arrangements 162 or 222 may each be provided with a magnetic core or ferrite core. A magnetic core (e.g. ferrite core) is a member, which being the core of a coil (throttle or transformer) increases its inductively or guides the magnetic field. A magnetic core for the antenna arrangements 162, 222 of the portable electronic device 100 and the external basic device 200, which are for example implemented as coils, may here for example be implemented as a C core, U core, E core, ER core, EFD core, Ring core, EP core or also an RM core.

The coupling factor of the coil arrangement 162 of the portable device 100 to the coil arrangement 222 of the external basic device 200 depends on the respective distance and the alignment (e.g. the angular offset) of the two antenna coils with respect to each other. Thus, for a high coupling factor, an as closely adjacent as possible, parallel and coaxial alignment of the coils of the antenna arrangements 162 and 222 is advantageous. The voltage now induced into the antenna arrangement or coil antenna 162 of the energy supply means 160 of the portable electronic device 100 may now for example after its rectification in a control circuit 162 be supplied to a charging means 166, wherein the charging means is implemented to charge a chargeable charge storage element 168, e.g. in the form of a chargeable battery or also a chargeable capacitor storage which is effective as a backup capacitor or bridging or short-term energy storage. Apart from that, the control circuit 164 may be implemented to further supply the optical, bidirectional data transmission means 140 and also the functional means 120 with energy as an output signal of the energy supply means 160. Optionally, the charging means 166, for its energy supply, may also be directly connected to the antenna arrangement 162, wherein then either in the antenna arrangement 162 or in the charging means 166 the requested rendering of the voltage induced into the antenna is executed.

Thus, the control circuit 164 is in particular implemented to supply the functional groups of the portable electronic device 100 with energy necessitated for the respective operation based on the energy E taken from the external magnetic field, in a state, in which the portable electronic device 100 is coupled to the external basic device 200. Should the portable electronic device 100 now be decoupled from the external basic device 200, i.e. be located at a greater distance (outside an effective coupling range), the control circuit 164 is implemented to extract energy from the charged charge storage element 168 for supplying the functional groups of the portable electronic device 100.

In particular, now the energy supply means 160 (for example as part of the control circuit 164) may comprise an external communication means 170 which is implemented to execute a data exchange (independent of the optical interface 142) with the basic device 120, wherein the data exchange is for example based on data associated with the energy transmission from the basic device 200 to the portable electronic device 100. Further, for example, also an optional (higher-level) processing means 122 may take over this function of the communication means 170. Here, for example, charge state information, energy requirement information or other control information for the basic device 200 generating the magnetic field may be transferred to the same. The transmitted data may thus, for testing the charge state of the chargeable charge storage element 168, comprise information on a sufficient or insufficient supply voltage in the portable electronic device 100, further device information, state information, operating information, interference/error messages (e.g. a low level indication) and corresponding data. Further, for example, the optional (higher level) processing means 122 may take over the coordination and/or control of the function of the functional means 120, the optical, bidirectional data transmission means 140 and/or the energy supply means 160.

As illustrated now in FIG. 1b, the energy provisioning means 220 comprises an antenna arrangement 222 and a control circuit 224. The antenna arrangement 222 for example comprises an antenna coil as an antenna, for example having m windings with or without a coil core. The control circuit 224 for example comprises a driver circuit for generating the carrier frequency f₀ of the emitted magnetic field. The energy provisioning means 220 may further optionally comprise a basic communication means 226 which is for example implemented to transfer data with a relatively low data rate to the energy supply means 160 of the portable electronic device 100. The basic communication means 226 may for example be arranged internally or also externally with respect to the control circuit 224 and further be implemented to directly exchange data with respect to energy provisioning by the external basic device 200 with the energy provisioning means 160 of the portable electronic device independent of other interfaces, like e.g. the optical, bidirectional communication means 214. Further, for example, also an optional (higher-level) processing means 260 may take over this function of the basic communication means 226. Here, for example, the basic communication means 226 may provide information with respect to data regarding switching on/off of the magnetic (or electromagnetic) field, settings of strength of the provided magnetic field, etc. for transfer.

The optional basic communication means 226 (or also the optional higher-level processing means 260) is thus implemented to execute a data exchange of data related to energy transmission from the basic device 200 to the portable electronic device 100 with the portable electronic device 100. The optical, bidirectional data communication means 240 implemented as an optical data interface now comprises a transmit/receive unit (an optical transceiver) 242 and an interconnected transmit/receive control and evaluation circuit 244. The control circuit 244 for example comprises a frontend circuit with a modulator, demodulator, clock and data recovery means (CDR) and an optional I/O interface for a connection to a base station or a peripheral device 300. The above functions may also be executed by the optional (higher-level) processing means 260. Thus, for example, portable multimedia-capable terminal devices 100, like e.g. mobile telephones, smartphones, notebooks, etc. or also a camera may be connected to a computer being the peripheral device 300 via the external basic device 200. Likewise it is of course also possible that a computer, a notebook, etc. is equipped with the inventive external basic device 200 to connect any portable terminal device for a conductor-less energy supply and data communication.

According to the present invention, a magnetic (or electromagnetic) field for an energy supply of the portable electronic device 100 is provided by the external basic device 200 or its energy provisioning means 220. The transmission or carrier frequencies f₀ for the magnetic field provided by the energy provisioning means 220 are, for example, in a range from approximately 10 KHz to 20 MHz. Here, the energy transmission from the external basic device 200 to the portable electronic device 100 is executed by means of an inductive coupling between the two antenna arrangements 162 or 242, effective as transformer coils, of the energy supply means 160 of the portable device 100 and the energy provisioning means 220 of the external basic device 200. The antenna arrangement 242 of the external basic device 200 which is for example implemented as a coil arrangement thus generates a magnetic alternating field with the respective transmission frequency f₀ which induces an alternating voltage in the antenna arrangement 162 of the portable electronic device 100 implemented as a coil arrangement.

As it will be illustrated the following, this induced voltage is rectified in the control circuit 160 of the portable device 100 and then provided to the different functional means and functional elements of the portable electronic device 100 by the energy supply means 160 for energy supply or serves as an energy supply for the portable electronic device 100. In the control circuit 164 of the portable device 100 connected to the antenna arrangement 162, typically an oscillating circuit is located whose frequency is set to the transmission frequency of the energy provisioning means 220 of the external basic device 200. In case of resonance, voltage induced in the antenna arrangement 162 is substantially increased as compared to frequencies outside the resonance band, which leads to an increase of efficiency of energy transmission from the external basic device 200 to the portable electronic device 100. The increase of efficiency of energy transmission between the antenna arrangements 162, 242 of the portable device 100 and the external basic device 200 by matching their resonance frequency to the transmission frequency of the basic device 200 minimizes the generated idle power and thus a so-called voltage excess in the energy supply means 160 of the portable electronic 100 is acquired. When the voltage across a coil or a capacitor acquires a higher value than the overall voltage, this is a voltage excess.

The effect of a voltage excess for example occurs in a series oscillating circuit. Here, in coil and capacitor the same current flows due to a series connection, wherein the sinusoidal voltages, however, show a phase shift of all in all π. The same is put together from the phase shift of the coil π/2 minus the phase shift at the capacitor of −π/2. This effect may now be utilized by presetting the complete voltage and tapping the voltage across one of the energy storages. For calculating the voltage the circuit may be regarded as a complex voltage divider. The voltage excess is highest with a resonance and is in this case proportional to the quality factor of the series oscillating circuit. Thus, with a series oscillating circuit of a quality Q with a resonance and an input voltage of U volts, a voltage excess of (Q×U) volts results at the capacitor or at the coil.

Apart from the coupling factor between the two antenna arrangements 162 and 242 of the portable device 100 implemented as coils and the external basic device 200 which, for example, results from the distance and alignment of the two antenna arrangements 162 and 242 (as loosely coupled transformator coils), the induced voltage at the antenna arrangement 162 of the portable device 100 and thus the resulting efficiency may be further increased or maximized by adapting the number of windings of the antenna arrangement 162 of the portable device 100 to the given transmission frequency f₀ of the external basic device 200. It is to be noted here that with an increase of the transmission frequency f₀ of the external basic device 200 less windings of the coil are necessitated in the antenna arrangement 162 of the portable device 100 in order to acquire the requested induced voltage at the antenna arrangement 162 of the energy supply means 160 of the portable electronic device when the field strength of the emitted magnetic field of the external basic device 200 is maintained.

In this context it is noted that the course of the distance-related decrease of the field strength of the magnetic field depends on the output power of the energy provisioning means 220 of the external basic device 200, the transmission frequency f₀ and also the diameter of the antenna arrangement 162 implemented as coils of the energy provisioning means 160 of the portable electronic device 100. The field strength of the generated magnetic (electromagnetic) field here decreases within a certain range, the so-called near field, approximately proportional to the third power (or potency) of the distance, and outside the near field, the so-called far field, approximately only directly proportional to the distance. The extent of the near field may be determined mathematically and is inversely proportional to the transmission frequency. As the inductive coupling only works in the near field, it thus presents a theoretical limit for the maximum range between the external basic device 200 and the portable electronic device 100. As the portable electronic device 100 should be directly lying on or at the external basic device 200, a very high inductive coupling may be acquired.

As the portable electronic device 100, if possible, is directly lying on the external basic device 200 or is arranged at the same for a conductor-less energy and data transmission according to the present invention (in order to acquire an alignment of the coils of the antenna arrangements 162 and 222 which is as closely adjacent, parallel and co-axial as possible), according to the invention a very high or maximum degree of coupling is guaranteed between the two devices (the external basic device 200 and the portable electronic device 100). As now, for example, the antenna arrangements 162 or 222 of the portable electronic device 100 and the external basic device 200 may be arranged at the exterior walls, i.e., at the exterior side, the interior side or also within the respective exterior walls, a distance of neighboring coils of the antenna arrangement 162 and the antenna arrangement 222 of less than, for example, 1 cm (or at least of less than 2 cm or 5 cm) may be acquired. The distance of neighboring, parallel antenna arrangements 162 and 222 is, for example, a distance between the parallel planes in which the coils of the neighboring antenna arrangements 162 or 222 of the portable electronic device 100 and the external basic device 200 are located.

For the possible (optional) data exchange already illustrated above between the energy supply means 160 of the portable electronic device 100 and the energy provisioning means 220 of the external device 200, i.e., for example, for exchanging data regarding energy transmission, basically any transmission types or modulation types may be used.

Thus, for example, for data transmission or data exchange from the communication means 226 of the energy provisioning means 220 of the external basic device 200 to the communication unit 170 of the energy supply means 160 of the portable electronic device 100 basically any modulation types of the transmission signal may be used, i.e., of the magnetic field provided by the energy provisioning means 220.

The data transmission (with a limited data rate) from the energy supply means 160 of the portable electronic device 100 to the energy provisioning means 220 of the external basic device 200 may now, for example, take place by means of load modulation. Data to be transmitted from the energy supply means 160 to the energy provisioning means 220 is here, for example, encoded as a digital signal which switches on and off a load resistance at the antenna arrangement 162. The changes of the resistance here change the counter inductivity of the antenna arrangement 162 of the energy supply means 160 which are detected by the energy provisioning means 220 of the external basic device in the form of small voltage changes. Data of the energy supply means 160 of the portable electronic device 100 which are up-modulated in this way are now demodulated, decoded and further processed by the communication means 222 of the energy provisioning means 220 of the external basic device 200, for example, in order to set the energy transmission to the portable external device 100 depending on the energy requirement based on this transmitted data. This way, for example, the necessitated field strength of the magnetic field to be provided by the energy provisioning means 220 may be set depending on the requirements of the portable electronic device 100.

Apart from the above-described load modulation for exchanging data related to the energy transmission from the external basic device 200 to the portable electronic device 100, any other type of modulation, e.g., amplitude shift keying (ASK), frequency shift keying (FSK), phase shift keying (PSK), quadrature amplitude modulation (QAM) may be utilized. Here, for example, the carrier signal generated by the external basic device 200, i.e., the magnetic (electro-magnetic) field generated at the transmission frequency is mixed 1/1 in the energy supply means 160 of the portable electronic device 100 and in a modulator the data signal to be transmitted to the external basic device 200 is up-modulated. The modulated data signal is then transmitted (more or less in parallel) in parallel to the continuous carrier signal generated by the external basic device 200. In this case it is to be noted, that a data transmission also according to the load modulation may only be done in a half-duplex method. On the secondary side, the portable electronic device 100 (i.e., the communication unit 170) may actively generate an additional magnetic or electromagnetic field for data transmission with a low data rate to the external basic device 200, e.g., in a half-duplex method or mode.

In the following, some possible implementations for the data exchange between the energy supply means 160 of the portable electronic device 100 and the energy provisioning means 220 of the external basic device 200 are illustrated.

As it is further illustrated in FIGS. 1a-b, the external basic device 200 for a conductor-less energy and data transmission further comprises the optical, bidirectional data communication means 240 for a conductor-less, optical data communication with the portable electronic device 100. As a counterpart, the portable electronic device 100 comprises the optical, bidirectional data transmission means 140 compatible thereto. Here, embodiments of the optical, bidirectional data transmission means 140 of the portable electronic device 100 and also the optical, bidirectional data communication means 240 of the external basic device 200 each comprise one or several optical interface elements 142 or 242 in order to establish the conductor-less optical data transmission (bidirectional), i.e., for example, in a full-duplex operation between the portable electronic device 100 and the external basic device 200. Using the optical communication technology very high data rates between the portable electronic device 100 and the external basic device 200 may, for example, be provided in a GBit/s range.

In particular, different amplitude modulation operations may be used for an optical data transmission between the optical interface elements 142 and 242 (2-ASK, 4-ASK . . . ), QAM (quadrature amplitude modulation) or DMT methods (DMT=discreet multi tone transmission). In addition, for example, FEC methods (FEC=forward-error correction) may be used, wherein depending on the case of application half- and/or full-duplex connections may be established. The efficiency of data transmission may, for example, be increased by transmitting (relatively) large data blocks without an additional individual confirmation of the receiver. Thus, for example, data transmissions with a frame size of 64 KB may be acquired. It is further possible to transmit a relatively high number of frames (e.g., 127 frames) one after the other before a confirmation is sent back from the receiver to the respective transmitter. This way, an effective reduction of the protocol overhead may be acquired.

By the reduction of the protocol overhead, the net data rate with the optical data transmission between the portable electronic device 100 and the external basic device 200 may, for example, be increased to more than 90% of the gross data rate, whereby an extremely efficient data transmission with an extremely high data throughput may be established.

In particular, due to the optical, bidirectional communication a very secure data communication may be established with respect to external interferences which may in particular be utilized world-wide due to non-existent regulations with respect to optical transmission standards and is, in particular, independent of electromagnetic interference or disturbance sources (EMV). As no international regimentation with respect to the optical data connection is to be considered, the inventive portable electronic device 100 and also the external basic device 200 may be designed for the world-wide market place without country-specific adaptations.

As the optical data transmission is based on a “visual connection” with respect to the inventive portable electronic device 100 and the external basic device 200 provided for a conductor-less energy and data coupling, in a technically relatively simple way highly secure data connections between these two devices may be established. It is additionally possible as compared to RF based approaches to implement a plurality of parallel optical interface elements with a relatively small space requirement and to each utilize the full bandwidth or a combination of all available bandwidths. Thus, for example, with a parallel operation of several channels, when coupling the inventive portable electronic device 100 to the external basic device 200 both in the half-duplex and also in the full-duplex mode, very high data rates of several GBit/s may be acquired which correspond to data rates in glass fiber networks. The optical data transmission between the respective interface elements 142 or 242 of the portable electronic device 100 and the external basic device 200 may, for example, be executed in the infrared range (with wavelengths from 850 to 900 nm), as the sensitivity in this wave range of the receiver diode is very high and noise or interferences of the surroundings as compared to visible light are relatively low. Of course, also wavelengths for the optical interfaces in the visible wavelength range may be used. In this respect, for example, to the portable electronic device 100 and/or to the external basic device 200, structural means for projection against parasitic light may be applied which make sure, when coupling the portable electronic device 100 to the external basic device 200, that no or as little as possible parasitic ambient light or scattered light impinges upon the optical interface elements 142, 242.

As the optical interface elements 142 or 242 of the portable electronic device 100 and/or the external basic device 200 may each be flush with the exterior walls of the associated device, the optical interface elements 142 or 242 (when coupling) of the portable electronic device 100 to the external basic device 200 may be brought into an opposing and directly adjacent arrangement. Optionally, for example, also optical coupling and decoupling elements or also transparent protective elements may be provided which provide a flush connection with the respective exterior walls of the portable electronic device 100 and/or the external basic device 200. Thus, the respective optical interface elements 142 or 242, when coupling the portable electronic device to the external basic device 200, may be arranged directly adjacent to each other.

If the optical interface element 142 of the portable electronic device 100 and/or the optical interface element 242 of the external basic device 200 is, for example, not flush with the exterior walls of the associated device, i.e., comprises a corresponding offset to the exterior walls, now the optical interface elements 142 and 242, when coupling the portable electronic device 100 to the external basic device 200, may be arranged opposite to each other but at least in a distance of, for example, less than 1 cm (or at least less than 2 or 5 cm). The distance then results from the respective offset of the interface elements 142 or 242 with respect to the exterior walls. Thus, in a relatively simple way a highly secure data connection between the two devices 100 and 200 may be established.

With reference to the figures illustrated in the following, now further alternative or optional embodiments and functional elements or functional units of the portable electronic device 100 and also of the inventive external basic device 200 and their functions are illustrated.

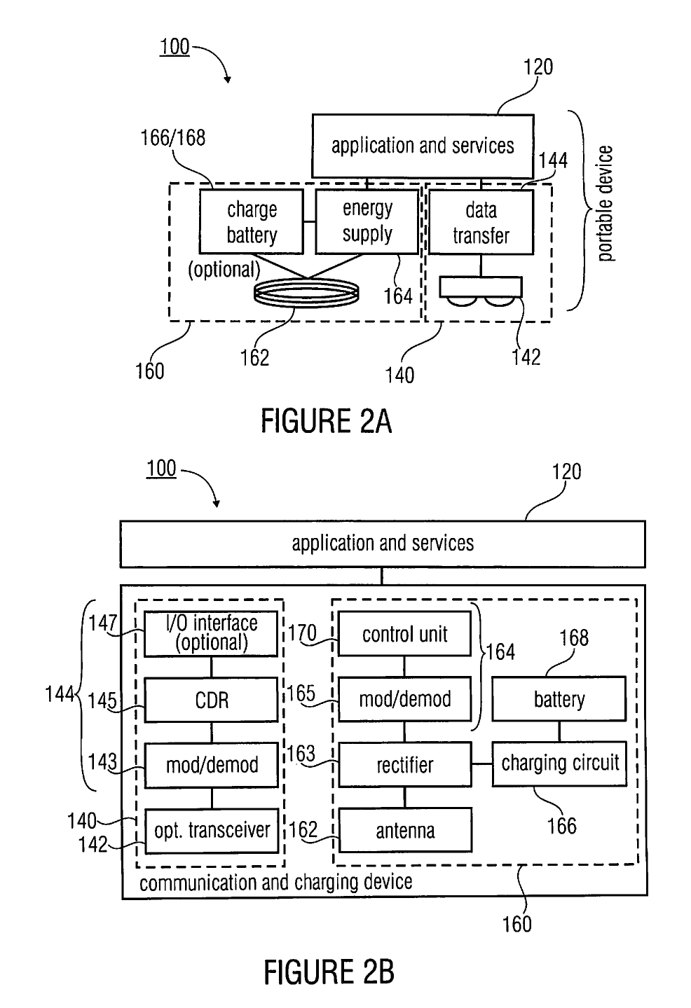

In a schematical diagram, FIG. 2a-b shows an inventive portable device, like, for example, a portable, multimedia-capable terminal device 100 with the associated functional units.

As illustrated in FIG. 2a, the portable terminal device 100 again comprises the functional means 120 for providing the electronic functionality, the optical bidirectional data transmission means 140 and the energy supply means 160. With the portable multimedia-capable terminal device 100 the functional means 120 may be implemented to process, execute and/or provide applications or services for an operator. In particular, the functional means 120 may optionally integrate one or several further I/O interfaces (I/O=Input/Output) as well as interfaces for the interaction with an operator. In this respect, for example, a touch sensitive display (touch screen), a keyboard, a mouse or other input aids may be used. The data transmission means 140 with the data transmission control means 144 and the optical interface element 142 are provided for establishing an optical data connection to an external basic device 200.

As further illustrated in FIG. 2a, the energy supply means 160 comprises an antenna arrangement 162 which is connected to the control circuit 164 and is optionally directly connected to a charging means 166 for a charge storage element 168. It is, of course, likewise possible for the charging means 166 to be integrated into the control circuit 164 so that the battery charging process is executed from the control circuit 164.

FIG. 2b now shows an overview of the functional units of the inventive portable electronic device, for example in the form of a portable, multimedia-capable terminal device 100. The optical, bidirectional data transmission means 140 for a conductor-less optical data communication with the external basic device 200 according to the embodiment of the present invention for example includes the antenna arrangement 162 implemented as a coil. The control circuit 164 now, for example, comprises a rectifier 163 for rectifying the voltage induced at the antenna arrangement 162 which comprises the transmission frequency f₀ of the magnetic field provided by the external basic device 200. The direct voltage provided by the rectifier may now be used by the charging circuit 166 to charge (if necessitated) the charge storage element 168, i.e., for example a chargeable battery or an accumulator.

The modulator and/or demodulator arrangement 165 is now further provided to demodulate data from the input signal detected by the antenna, e.g., control information transmitted from the energy provisioning means 220 of the external basic device 200 and to provide the same to the control unit 170 or the communication means 164 or also to the (optional) higher level processing means 122. The control unit 170 or communication means 164 is now again capable, for example, based on the battery state or charging state of the chargeable battery 168 or the energy requirements of the complete portable electronic device 100 to generate data or control information (relating to the energy transmission from the basic device 200 to the portable electronic device 100). The modulator means is now further provided to modulate the data to be transmitted of the data supply means 160 and to control the antenna via an optional control circuit (not illustrated in FIG. 2b) in order to transmit this data or control information to the energy provisioning means 220 of the external basic device 200. The integrated supply means 160 of the portable electronic device 100 is now provided, during the state in which it is coupled to the external base station 200 to, for example, supply all functional elements or assemblies of the portable electronic device 100 with energy and, if the coupling to the external basic device 100 is disconnected, to provide the energy supply of the portable electronic device 100 completely and if possible without interruption from the chargeable battery 168 (without support of the external basic device 200).

The optical, bidirectional data transmission means 140 of the inventive portable electronic device 100 for example includes an optical transceiver 142 which exists, for example, in the form of optical interface elements or optical transmit/receive diodes. The term transceiver should indicate a bidirectional data communication with the optical, bidirectional data communication means 240 of the external basic device 200.

Further, a modulator/demodulator means 143 is associated with the optical transceiver 142 to demodulate signals received from the optical transceiver 142 and to recover the modulation signal or base band signal, i.e., the received transmission signal. Apart from this, the optical, bidirectional data transmission means 140, for example, comprises a CDR means or clock recovery means 145 (CDR=Clock/Data Recovery), in order to determine the transmission clock f₀ of the transmitter 240 of the external basic device 200 from the received signal and thus enable the exact sampling of the receive signal. Clock recovery may also be necessitated to correctly temporally align, i.e., to synchronize a signal transmitted back in the opposite direction. Clock recovery is, for example, necessitated on the receiver side in order to determine the periodic sampling times of the received data stream. This temporally exact alignment is necessitated in order to be able to correctly evaluate the digital receive signal and to present a number of bit errors which is too high in the recovery of the receive signal.

Optionally, now further I/O interfaces 147 (I/O=Input/Output Interface) may be provided for example to represent data acquired from the external basic device 200 on a user interface or to execute an application or a service of the functional means 120 or supply the same with data or transmit the data generated in the portable electronic device 100 to the external basic device 200, etc.

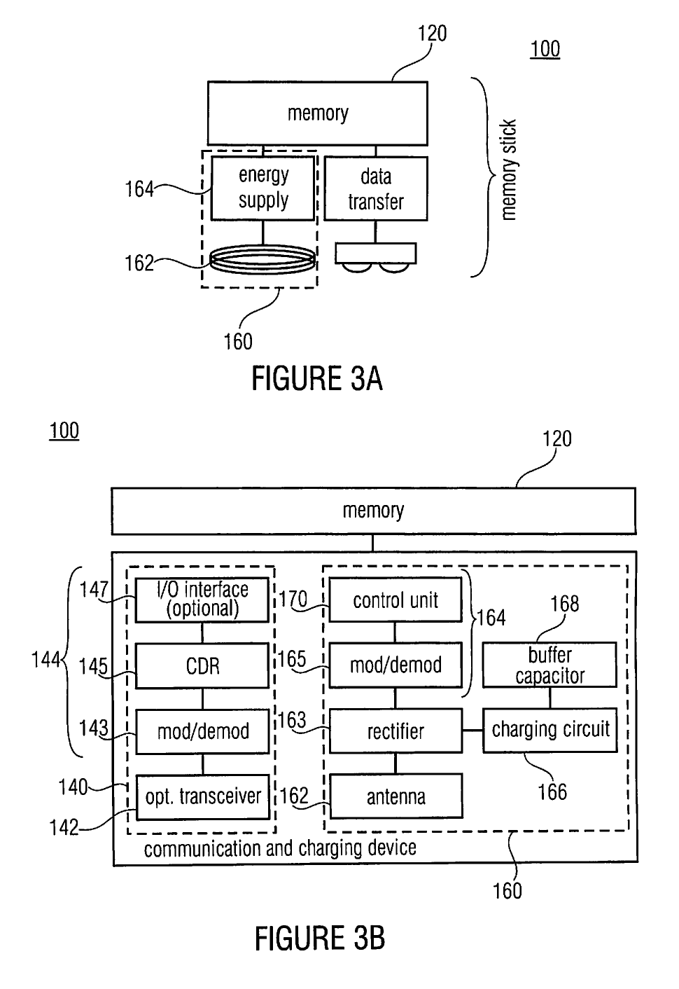

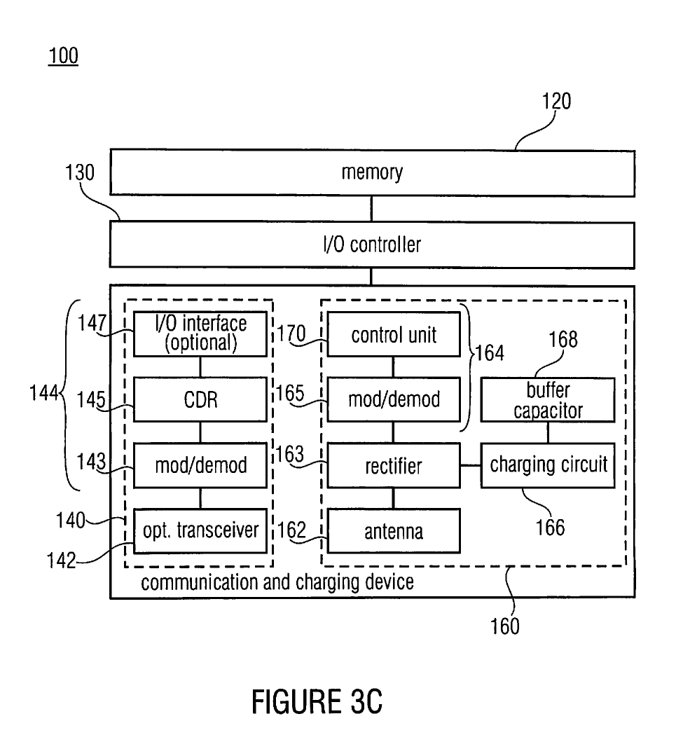

In the following, now with reference to FIGS. 3a-c, the portable electronic device 100 in the form of a portable data storage is described, wherein the functional means 120 here comprises a mass storage element or a non-volatile memory to store data as an electronic functionality and provide stored data again on request.

In order to prevent repetitions, functional elements and functional units of the portable electronic device 100 which were already described above and which may likewise be used for a portable data storage 100 are not described again.

As illustrated in FIG. 3a, the portable data storage 100 thus comprises a mass storage element as a functional means 120 for storing data and for providing the stored data upon request. The optical, bidirectional data transmission means 140 is implemented according to the above illustrated embodiments.

The energy supply means 160 for the portable data storage data 100 is different from the above illustrated embodiments in that for a portable data storage 100 generally no rechargeable battery is necessitated as the portable data storage 100 is only provided during coupling to the external basic device 200 for storing and upon request for providing data. Thus, the energy supply means 160 of the portable data storage data 100 is, for example, implemented to supply the same with energy only during coupling to the external basic device 200 as only during this period of time a data exchange with the external basic device 200 or with a peripheral device 300 connected thereto (see FIG. 1b) is necessitated.

In the following, now with reference to FIG. 3b, possible functional units of the portable data storage 100 are illustrated. As illustrated as an example in FIG. 3b, the portable data storage comprises a unit for energy recovery (i.e., the energy supply means 160), an optical data transmission unit (in the form of the optical, bidirectional data transmission means 140) and a functional block in the form of a storage element for storing data. As a storage element non-volatile memories such as a flash memory, a hard disc, an SSD hard disc (SSD=Solid State Disk), an NVRAM with associated controller circuits are possible.

With respect to the functional set up of a portable data storage 100 illustrated in FIG. 3b, it becomes clear according to embodiments of the present invention that, with respect to the hitherto illustrated embodiments, the functional means 120 is not implemented as a non-volatile data storage and that instead of a chargeable battery a chargeable capacitor storage 168, for example in the form of a bridging or short time energy storage (supporting capacitor) is provided whose function it is to bring the portable data storage into a defined state of rest when (e.g., unintendedly) removing the same from the external basic device 200. Accordingly, the charge circuit 160 is only to be implemented to bring the buffer capacitor to a predefined charging state, so that no extensive functionality is to be provided with respect to controlling the charging process of a chargeable battery storage. It is only necessitated to supply the supporting capacitor 168 with energy.

The buffer capacitor now ought to be implemented sufficiently large to even supply the portable data storage 100 with energy for a sufficiently long period of time after a coupling to the external base station 200 has been terminated intendedly or unintendedly in order to, for example, terminate a write process of data into the storage area or, in case of using a hard disc, to bring the write/read head into a defined position of rest. In particular, the supporting capacitor may also be provided to establish a bridging of the energy supply with short-time voltage changes or interruptions of the energy supply from the coupled external basic device 200.

As illustrated as an example in FIG. 3c, with the inventive portable data storage 100, further an I/O controller 130 may be provided between the optical, bidirectional data transmission means 140 and the memory element 120 which, for example, emulates one of a plurality of possible data transmission protocols for the external basic device 200 or a peripheral device 300 or its operating system connected to the basic device. Thus, between the optical, bidirectional data transmission means 140 and the memory block 120 as a further functional block the I/O controller 130 may be integrated which, for example emulates a wire-bonded (USB, Ethernet, FireWire, SATA, eSATA) or a wireless (WLAN, Wireless USB, Bluetooth) protocol. Thereby, the portable data storage may be detected or integrated more easily via the existing, higher-level protocol layers as a storage medium in the operating system, for example of the external basic device 200 or a peripheral device 300 connected thereto. The optical, bidirectional data transmission means 140 may now be implemented to adapt the signal rate using which data is read out of the memory block or provided to the same to the size and write speed of the storage medium. Apart from this, the portable data storage 100 may optionally comprise I/O interfaces for an interaction with an operator, for example LEDs, a display, a feeler or a keyboard, etc.

Thus, the portable electronic device 100 may provide the function of a completely plugless data storage, for example a memory stick or a portable plugless hard disc. This way, such a portable data storage 100 may then simply be deposited at an external basic device 200 in a certain coupling or deposition area, wherein in this respect, for example, a mechanical or magnetic fixing may be provided. Via the wireless energy transmission from the external basic device 200, the portable data storage 100 is supplied with energy for the active operation. The optical high-speed data transmission via the optical, bidirectional data transmission means 140 is used for the transfer of data (read/write).

Like with the other illustrated embodiments, the unit for inductive energy production, i.e., the energy supply means 140, may comprise an antenna arrangement 162 implemented as a coil, i.e., an antenna coil with or without coil core, a rectifier and a circuit for voltage stabilization. Optionally, further an additional communication unit 164 or 170 may be arranged or integrated which utilizes the electromagnetic coupling between the portable data storage 100 and the external basic device 200 to transmit control information, for example related to energy transmission from the basic device 200 to the portable data storage 100, to the external basic device 200. The control information transmitted to the external basic device 200 for example relate to the fact that the magnetic field provided by the external base station is to be switched on or off, whether a sufficient supply voltage is acquired in the portable data storage or whether the portable data storage is active at all.

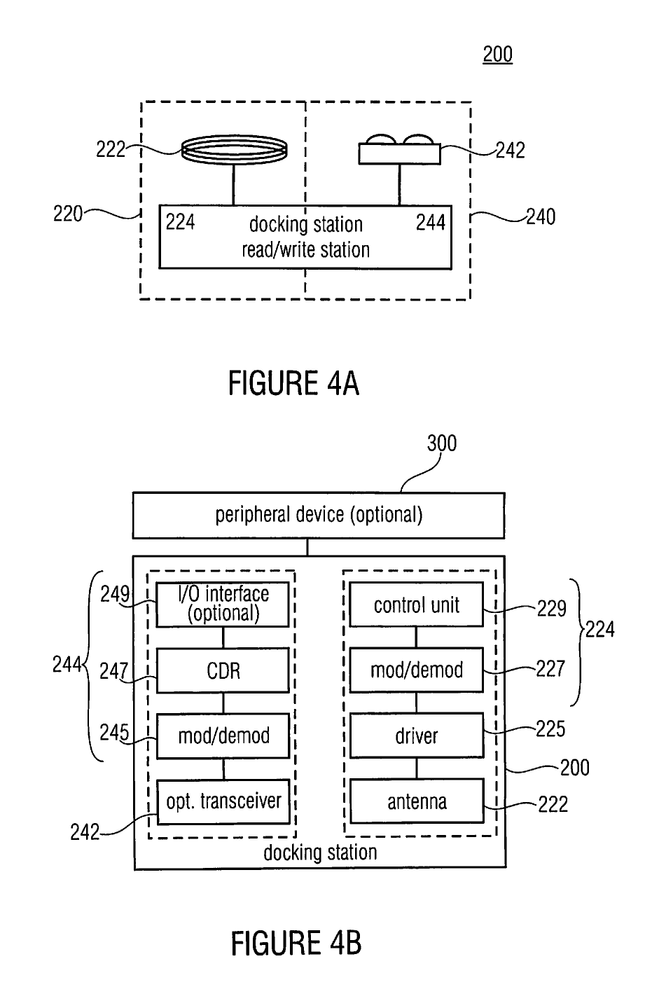

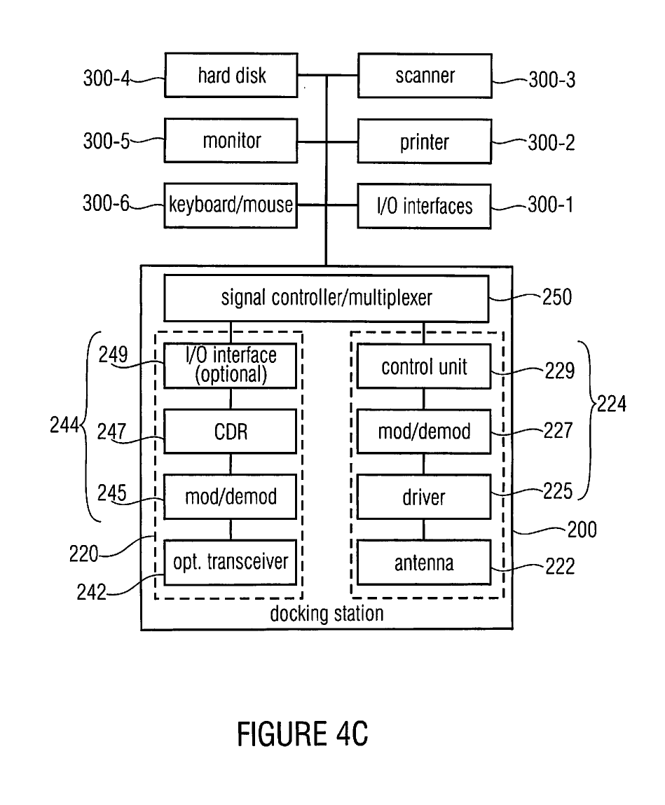

In the following, now with reference to FIGS. 4a-c, further embodiments and optional alternatives for functional units of the inventive basic device 100 for a conductor-less energy and data transmission to the portable electronic device 100 are illustrated.

As illustrated in FIG. 4a, the external basic device 200 comprises the energy provisioning means 220 for generating a magnetic field for an energy supply of the portable electronic device 100 by means of an inductive coupling from the generated magnetic field, and to an optical, bidirectional data communication means 240 for a conductor-less, optical data communication with the portable electronic device 100. In particular, the external basic device 100 may be used as a so-called docking station for a portable, multimedia-capable terminal device or as a read/write station for a portable data storage.

As illustrated in FIG. 4b, the energy provisioning means 220 for example comprises the antenna 222, a driver circuit 225, a modulator/demodulator 227 and a control unit 229. The optical, bidirectional data communication means 240 of the external basic device 200 for example again comprises an optical transceiver 242, a modulator/demodulator 245, a CDR circuit 247 and optionally an I/O interface 249.

The wireless charging device 220 now comprises the antenna arrangement 222 in the form of an antenna coil with or without a coil core, a driver circuit 225 for the generation of the carrier frequency f₀ and optionally a communication system 224 (with the control unit 229) for transmitting control information with respect to the energy supply of the portable electronic device 100. The communication system 224 optionally implemented in the energy provisioning means may directly exchange data with the energy supply means (charging circuit) in the portable electronic device 100 independent of the optical interface 242, wherein the data for example relates to a switching on/off of the provided magnetic field, testing the charging state or a sufficient supply voltage in the portable electronic device 100.

The modulator/demodulator means 245 is associated with the optical transceiver 242 to demodulate the signals received from the optical transceiver 242 and to recover the baseband signal, i.e., the received transmit signal. Apart from this, the optical, bidirectional data transmission means 240, for example, comprises the CDR means or clock recovery means 247 (CDR=Clock/Data Recovery) to determine that transmission clock f₀ of the transmitter 160 of the portable electronic device 100 from the received signal and thus enable the exact sampling of the receive signal.

The external basic device 200 may now, for example, be connected to an optional peripheral device 300. Alternatively, the external basic device 200 itself may be part of a peripheral device, e.g., a PC (PC=Personal Computer) or Notebook. The external basic device 200, for example, implemented as a docking station or as a read/write station, thus contains a wireless charging arrangement in the form of the energy provisioning means 220 as well as an optical data interface in the form of the optical, bidirectional data communication means 240. Additionally, at the external basic device 200 an arrangement for a mechanical or magnetic fixation of the portable electronic device 100 may be integrated or provided, by means of which a secure coupling for a conductor-less energy and data transmission between the external basic device 200 and the portable electronic device 100 is enabled. This fixation means may now, for example, be implemented so that the portable electronic device may be arranged or fixed in a predetermined position (e.g., secure from exchanging) to the external basic device so that an optimum magnetic coupling of the two antenna arrangements 162 or 222 and further a coupling as optimum as possible of the two optical interfaces 142 or 242 of the portable electronic device 100 and the external basic device 200 with respect to each other is enabled.

Further, the fixation means may be implemented to, for example, attenuate or receive (limited) mechanical influences, e.g., vibrations, slight impacts, etc., so that also with a certain mechanical load no offset between the portable electronic device 100 and the external basic device 200 occurs and so that an efficient and secure conductor-less energy and data transmission between the two devices may further be guaranteed and should not lead to an interruption of the energy and/or data transmission between the two devices.

The optical, bidirectional data transmission means 240 for a conductor-less optical data communication with the portable electronic device 100 thus comprises the optical transceiver 242, a front end circuit with a modulator/demodulator 245, clock and data recovery 247 (CDR) and optionally an I/O interface 249 for the connection to a peripheral device 300. Thus, for example, typical fields of application of the inventive basic device represent the connection of a mobile telephone or a camera to a computer.

The functional units here again execute the functions described above with reference to different embodiments.

As illustrated in FIG. 4c, the external basic device 200 may also support or provide the function of a port replicator. A port replicator is an arrangement wherein further terminals or interfaces are provided separately, so that at one output of the external basic device 200 further different peripheral devices 300-n may be connected and then again disconnected. Thus, for example, as further peripheral devices a mouse of a computer, a printer, a USB port, a monitor, a further external hard disk, a scanner, further I/O interfaces, a keyboard, etc. may be connected. If the inventive external basic device 200 supports or provides the functionality of a port replicator, e.g. a notebook or a mobile telephone (smart phone or any portable multimedia-capable terminal device) may be connected to different peripheral devices, like e.g. a keyboard or mouse, a screen, one or several external hard disks, a printer, a scanner, etc. or the number of available I/O interfaces may be increased. Data (serially) transferred between the external basic device 200 and the portable electronic device 100 may be distributed to the individual further devices or interfaces by a signal controller or a multiplexer 250.

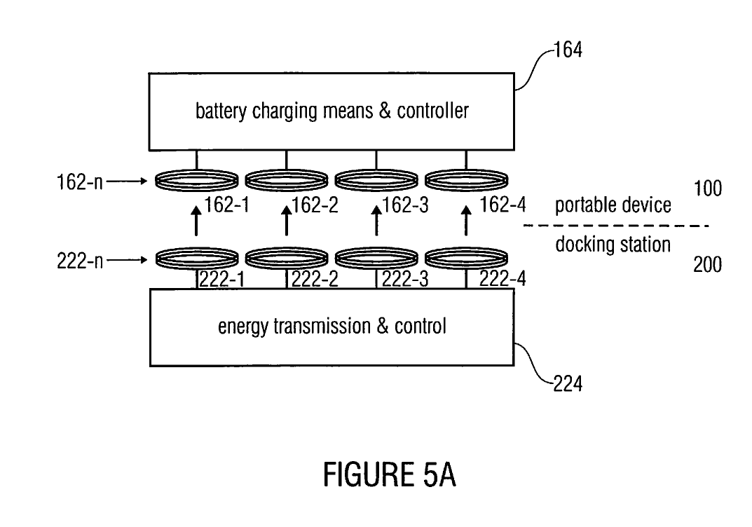

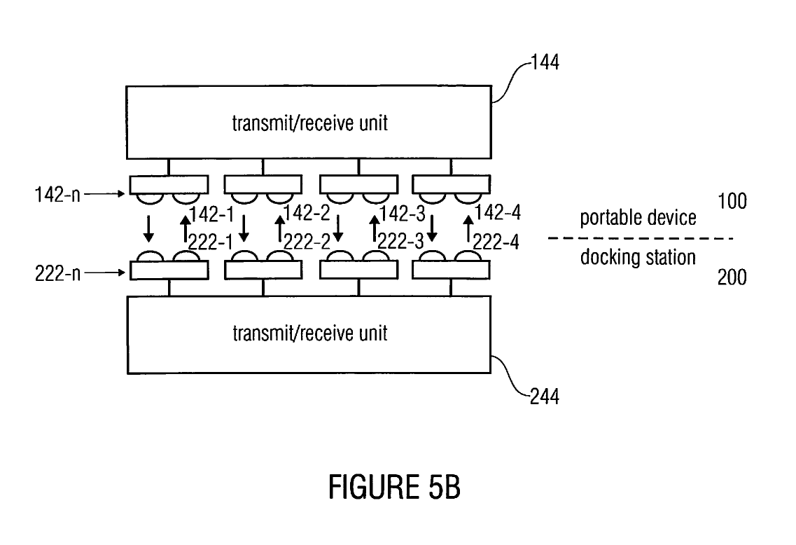

With reference to FIG. 5a-b, now further alternative and optional implementations of the inventive portable electronic device 100 and the external basic device 200 are illustrated.

As illustrated now in FIG. 5a, the energy supply means 160 of the portable electronic device 100 may comprise a plurality of antenna arrangements 162-n for energy absorption by means of an adaptive coupling from the magnetic field provided by the external basic device 100. The energy supply means 160 may now comprise a control functionality to selectively connect or disconnect individual antenna arrangements 162-1/2/3/4 of the plurality of antenna arrangements 162-n for energy absorption to or from the energy supply means 160 depending on the energy requirement of the portable electronic device 100. In particular, the energy supply means 160 may be implemented to determine the respective antenna arrangement or also several antenna arrangements from the plurality of antenna arrangements 162-n which comprise an increased degree of coupling or the highest degree of coupling to the magnetic field provided by the external basic device 200 as compared to at least one of the other antenna arrangements and to connect this one or several antenna arrangements having an increased degree of coupling to the energy supply means 160 for energy absorption by means of an inductive coupling from the magnetic field provided by the external device 200.

Optionally, further the external basic device 200 may comprise a plurality of antenna arrangements 222-n for generating the magnetic field for an energy supply of the portable electronic device 100. Here, the energy provisioning means 220 may comprise a control functionality to selectively connect, depending on the energy requirement of the portable electronic device 100, individual antenna arrangements 222-1/2/3/4 of the plurality of antenna arrangement 222-n, to the energy provisioning means 220 or disconnect them from the same for energy supply. Further, the energy provisioning means 220 may be implemented to determine the one antenna arrangement or several antenna arrangements of the plurality of antenna arrangements 222-n which comprises an increased degree of coupling to the antenna arrangement 162 of the portable electronic device 100 as compared to at least one of the other antenna arrangements, wherein the energy provisioning means 220 is further implemented to selectively connect the antenna arrangement(s) having an increased degree of coupling to the antenna arrangement 222 for generating a magnetic field or also to disconnect the same.

According to the invention, thus several antenna coils of the antenna arrangement 222 for example arranged in parallel may adapt the transmitted power between the external basic device 200 and the portable electronic device 100 to the respective energy requirement of the portable electronic device 100 by, for example, selectively connecting or disconnecting individual antenna arrangements 162-n each in the portable electronic device 100 and individual antenna arrangements 222-n in the external basic device 200 to or from the respective antenna arrangement 162 or 222 in order to provide the respective energy requirement between the two devices as efficiently as possible.

The antenna arrangements 162-n may thus be arranged in the portable electronic device 100 so that the device may be arranged in different positions at the external basic device 200, be plugged into the same or coupled to the same in order to enable charging the chargeable battery or the current supply of the external device. Via a detector circuit (not illustrated in FIG. 5a), which for example determines the respective value of the induced voltage and thus indirectly the degree of coupling at the individual antenna arrangements, for example the one antenna arrangement 162 may be activated which may be used for energy transmission between the external basic device 200 and the portable electronic device 100.

As it is further illustrated in FIG. 5b now, the optical data transmission means 140 of the portable electronic device 100 may comprise a plurality of optical interface elements 142-n for establishing a conductor-less optical data transmission to the external basic device 200. The optical data transmission means 140 may be further associated with a control means 144 which is implemented, depending on the bandwidth requirement for the communication between the portable electronic device 100 and the external basic device 200, to activate or to deactivate individual optical interface elements of the plurality of optical interface elements 222-n for the data transmission to the optical data transmission means 140.

If now, for example, the functional means 120 comprises, executes, or provides a plurality of electronic functionalities, i.e. applications or services, the control circuit 164 of the energy supply means 160 my now further execute this function to allocate the data communication with the external basic device 100 to one optical interface element 162 each of the plurality of optical interface elements 162-n (if the external basic device 200 comprises corresponding optical interface elements 222), so that the data communication associated with an electronic functionality of the functional means 120 is each associated with an optical interface element 162 or a group of optical interface elements. Further, the control circuit 164 of the energy supply means 160 of the portable electronic device 100 may be implemented to determine the optical interface element or the optical interface elements from the plurality of optical interface elements 162-n which may setup a conductor-less, optical communication connection with the external basic device 200 when coupling the portable electronic device 100 to the external basic device 200.

Likewise, the optical, bidirectional data communication means 240 of the basic device 200 may comprise a plurality of optical interface elements 222-n for establishing a conductor-less, bidirectional, optical data communication with the portable electronic device 100. Here, a control circuit 244 may be associated with the optical data communication means 240 which is implemented, depending on the bandwidth requirement for the communication between the basic device 200 and the portable electronic device 100, to activate or deactivate individual optical interface elements 222 from the plurality of optical interface elements 222-n for data transmission in the optical data transmission means 240. Further, the control circuit 244 may be implemented to allocate the data communication associated with an electronic functionality of the portable electronic device 100 to the portable electronic device 100 to an optical interface element of the plurality of optical interface elements 222-n.

Further, the control circuit 244 may be implemented to determine the optical interface element or several optical interface elements from the plurality of available optical interface elements 222-n, which may basically setup an optical conductor-less communication connection to the portable electronic device when coupling the basic device 200 to the portable electronic device 100.

In summary it may thus be noted with respect to FIG. 5, that both at the external basic device 200 (docking station) and also at the portable electronic device 100 one or several additional optical interface elements each may be arranged or integrated. On the one hand, the bandwidth may be increased to several GBit/s by a parallelization of the optical interface elements. The data is in this respect divided onto individual channels in the respective transmitter, transmitted simultaneously and passed on in the respective receiver to the individual applications. This data does not have to be transmitted in a slower time multiplex operation. The individual optical interfaces may be selectively connected depending on the data transmission requirement and e.g. by an allocation to an application.

On the other hand, the portable electronic device may be coupled to the external basic device 200 in different (but predefined) positions and communicate with the external basic device by means of a mechanical arrangement provided thereon and for example a corresponding mechanical counterpart at the external basic device 200. With the help of a detector circuit (not illustrated in FIG. 5) which may for example be implemented with the optical interface elements 142-2 or 222-2, it is the one optical interface or those optical interfaces which are activated which may setup a connection with the external basic device.

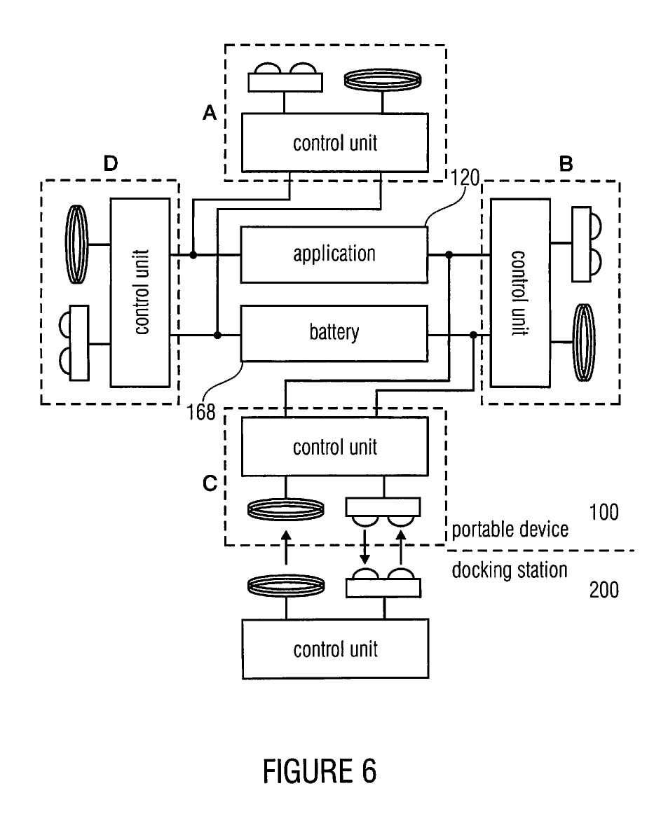

In FIG. 6 now an arrangement is illustrated, wherein the portable electronic device 100 comprises a plurality of groups A-D of at least one optical, bidirectional data transmission means 140 and at least one energy supply means 160 arranged in groups each at one or several lateral surfaces of the portable electronic device 100.

Thus, for example groups A-D of data transmission means 140 and energy supply means 160 may each be arranged symmetrically at the portable electronic device 100, so that with a random arrangement of the portable electronic device in a (already described above) fixation means at the external basic device 200 a conductor-less energy and data transmission each may be established between the portable electronic device 100 and the external basic device 200.

Thus, for example, at one, several or all side or lateral surfaces of the portable electronic device 100 at predefined positions one or several groups of an energy supply means 140 and an optical, bidirectional data transmission means 160 may be provided in order to be able to establish a conductor-less energy and data transmission with the external basic device 200. Likewise, at the external basic device 200 several “slots” may be provided for several portable electronic devices 100 which are for example given by special fixation means.

Here, for example, the special fixation elements may be implemented at the external basic device 200 to be either compatible with a special portable electronic device 100 or to be able to only receive the same or receive any portable electronic devices 100 provided with corresponding counterparts with respect to the fixation means.

With reference to the above description of the inventive portable electronic device it ought to be obvious that the portable electronic device 100, for example for the optical, bidirectional data transmission means 140 and the energy supply means 160 or for controlling and coordinating the same may each comprise an individual control means 144 or 164 or optionally also a common higher-level control means 122 (see FIG. 1). Thus, for example, the optional (higher-level) processing means 122 may take over the coordination and/or control of the function of the functional means 120, the optical, bidirectional data transmission means 140 and/or the energy supply means 160.

The same applies to the external basic device 200, wherein for controlling and coordinating the energy provisioning means 220 and the optical bidirectional data communication means 240 each an individual control means 224 or 244 or optionally also a common higher-level control means 260 (see FIG. 1) may be provided.

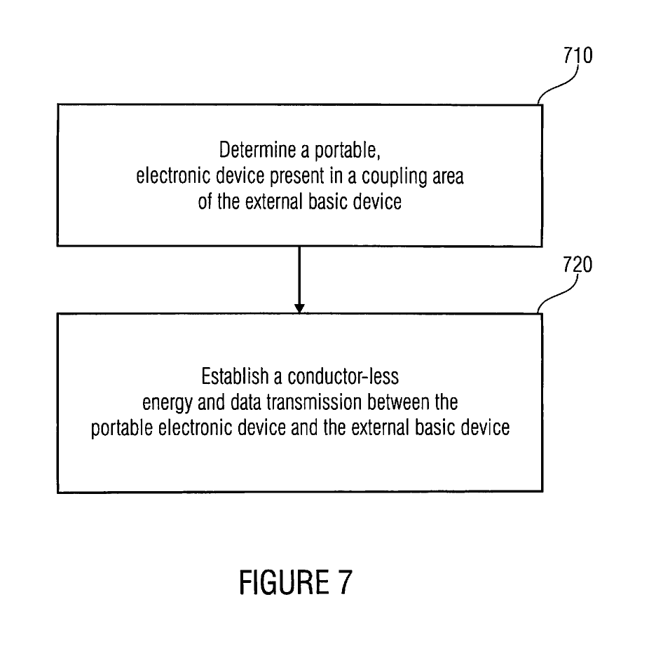

In the following, with reference to FIG. 7, an inventive method 700 for coupling a portable electronic device 100 to an external basic device 200 is described. Here, first of all in a first step 710 a portable electronic device present in a coupling area of the external basic device 200 is determined, whereupon in a further step 720 a conductor-less energy and data transmission is established between the portable electronic device 100 and the external basic device 200. According to the invention, an antenna arrangement may be determined from a plurality of antenna arrangements 162-n of the portable electronic device 100, which comprises a higher degree of coupling to the magnetic field provided by the external basic device 200 at least compared to one of the other antenna arrangements, wherein the antenna arrangement with the increased degree of coupling may be switched in for energy absorption by means of inductive coupling from the magnetic field provided by the external basic device.

Further, an optical interface element may be determined from a plurality of optical interface elements of the portable electronic device which may setup a conductor-less, optical communication connection with the external basic device when coupling the portable electronic device to the external basic device.

Further, an antenna arrangement may be determined from a plurality of antenna arrangements of the external basic device, which comprises an increased degree of coupling to the portable electronic device as compared to at least one of the other antenna arrangements, wherein then the antenna arrangement with the increased degree of coupling may be connected to the energy provisioning means for generating a magnetic field for the energy supply of a portable electronic device. Finally, an optical interface element may be determined from a plurality of optical interface elements of the external basic device which may setup an optical, conductor-less communication connection to the portable electronic device when coupling the basic device to the portable electronic device.

Thus, according to the inventive concept for a conductor-less energy and data transmission between a portable electronic device and an external basic device it is possible that for improving the degree of protection both of the portable electronic device and also of the external basic device with respect to environmental influences no extensive special solutions have to be utilized, so that the inventive concept provides an increased lifetime and a very simple handling of corresponding devices. In particular, adaptations for special applications may be realized in industry, medical technology or consumer electronics with a relatively low effort and maintaining the complete functional extent without special protective measures. Above described inventive plug-less approaches for portable terminal devices and associated external basic devices for a conductor-less energy and data transmission thus enable the realization of very robust, dust- and waterproof devices for a simple handling by the respective operator. This is enabled by the inventive implementation of a wireless data and energy transmission.

Apart from the extremely robust and user-friendly implementation of portable electronic terminal devices and associated base stations, additionally a highly efficient system is acquired with respect to acquirable data transmission rates with high net data rates. These high data rates in particular meet today's requirements with respect to data rates in the GB Ws range with portable memory sticks, hard disks and docking stations, e.g. with the connection of HD screens, external hard disks or cameras. Apart from providing a high data rate, further a wireless approach for energy transmission is realized, as only by the combination of conductor-less data and energy transmission a very robust, plug-less, portable terminal device having improved operating characteristics may be provided and in particular be adapted to fields of applications still to be opened up without extensive effort.

Although some aspects of the present invention were described in connection with devices, it is obvious that those aspects also represent a description of corresponding methods, so that a functional block or an element of a device may also be regarded as a corresponding method step or as a feature of a method step. Analog to this, aspects which were described in connection with or as a method step also represent a description of a corresponding functional block of detail or feature of a corresponding device.

Depending on certain implementation requirements, embodiments of the invention may be implemented in hardware or in software. The implementation may be executed using a digital storage medium, for example a floppy disk, a DVD, a Blu-ray disc, a CD, an ROM, a PROM, an EPROM, an EEPROM, or a flash memory, a hard disk or any other magnetic or optical memory on which electronically readable control signals are stored which cooperate or may cooperate with a programmable computer system such that the respective transmit/receive method is executed. Thus, the digital storage medium may be computer readable. Some embodiments according to the invention thus include a data carrier comprising electronically readable control signals which are capable of cooperating with a programmable computer system or a digital signal processor such that one of the methods described herein in executed.

In some embodiments, a programmable logic device (for example a field programmable gate array, an FPGA) may be used to execute some or all functionalities of the methods described herein. In some embodiments, a field programmable gate array may cooperate with a microprocessor to execute one of the methods described herein. In general, in some embodiments the methods are executed by any hardware device. The same may be a universally usable hardware like a computer processor (CPU) or hardware which is specific for the method, like for example an ASIC.

The above described embodiments only represent an illustration of the principles of the present invention. It is obvious that modifications and variations of the arrangements and details described herein are obvious to other persons skilled in the art. It is thus the object that the invention is only limited by the scope of the appended patent claims and not by the specific details presented herein by the description and the explanation of the embodiments.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

According to one aspect, a portable electronic device comprises a functional means for providing an electronic functionality; an optical data transmission means for a conductor-less, optical data communication with an external basic device; and an energy supply means for energy absorption by means of an inductive coupling from a magnetic field emitted from the external basic device and for supplying the functional means and the data transmission means with energy based on the energy taken from the external magnetic field.

The energy supply means may further comprise a chargeable charge storage element and is further implemented to charge the chargeable charge storage element based on the energy taken from the external magnetic field.

The energy supply means may be implemented to supply the functional means with energy from the chargeable charge storage element when the portable electronic device is decoupled from the basic device.

The charge storage element may be implemented as a chargeable battery or as a chargeable capacitor storage.

According to a further aspect, the energy supply means of the portable electronic device may comprise a communication means which is implemented to execute a data exchange of data relating to the energy transmission from the basis device, with the basic device, wherein data relating to the energy transmission comprises control information for the basic device generating the external magnetic field for providing the external magnetic field, wherein the communication unit is implemented to execute the data exchange of the data relating to the energy transmission by means of load modulation.

According to a further aspect, the energy supply means of the portable electronic device may comprise an antenna arrangement or a plurality of antenna arrangements for energy absorption by means of an inductive coupling from the magnetic field provided by the external basic device, wherein a control means is associated with the energy supply means, wherein the control means is implemented, depending on the energy demand of the portable electronic device, to connect individual antenna arrangements of the plurality of antenna arrangements, for energy absorption, to the energy supply means or disconnect the same, wherein the control means is implemented to determine the antenna arrangement of the plurality of antenna arrangements which has an increased degree of coupling with the magnetic field provided by the external basic device as compared to the other antenna arrangements and which is further implemented to connect the antenna arrangement having the increased degree of coupling to the energy supply means, for energy absorption by means of inductive coupling from the magnetic field provided by the external basic device, wherein the plurality of antenna arrangements for energy absorption are arranged distributed at one or at several side surfaces of the portable electronic device.

According to a further aspect, the optical data transmission means of the portable electronic device may comprise an optical interface element or a plurality of optical interface elements for establishing a conductor-less, optical data transmission with the external basic device.

A communication control means may be associated with the optical data transmission means, wherein the communication control means is implemented, depending on the bandwidth requirement for the communication between the portable electronic device and the external basic device, to activate or deactivate individual optical interface elements of the plurality of optical interface elements for the data transmission to the optical data transmission means.

The functional means may comprise a plurality of electronic functionalities, wherein the communication control means is implemented to allocate the data communication with an external basic device associated with an electronic functionality of the functional means to an optical interface element of the plurality of optical interface elements

The communication control means may further be implemented to determine the optical interface element of the plurality of optical interface elements which may set up a conductor-less, optical communication connection with the external basic device when coupling the portable electronic device to the external basic device.

The optical interface element or the plurality of optical interface elements may further be implemented to execute the conductor-less, optical data transmission to the external basic device in the infrared range.

According to a further aspect, the portable electronic device may be implemented as a mobile telephone, notebook, tablet PC, E-Reader or digital camera, wherein the functional means may be implemented to execute an application or a service as an electronic functionality.

The portable electronic device may further be implemented as a portable data storage, wherein the functional means comprises a mass storage element to store data and provide the same upon request as an electronic functionality.

The portable electronic device may further be implemented as a telemonitoring device for monitoring persons or patients, wherein the functional means may be implemented to detect medical or physiological data of persons or patients as an electronic functionality and to evaluate the detected data or provide the detected data to the external basic device or to a peripheral device for evaluation connected to the same by an interface.

According to a further aspect, the portable electronic device may be completely hermetically encapsulated with respect to gaseous or liquid environmental influences.

According to a further aspect, the portable electronic device may comprise further data interfaces and/or an interaction interface for an operator.

According to another aspect, a basic device for energy and data transmission to a portable electronic device comprises an energy provisioning means for generating a magnetic field for an energy supply of the portable electronic device by means of an inductive coupling from the generated magnetic field; and an optical, bidirectional data communication means for a conductor-less, optical data communication with the portable electronic device.

The energy provisioning means may further comprise a basic communication means which is implemented to execute a data exchange of data relating to energy transmission from the basic device to the portable electronic device with the portable electronic device.

The energy provisioning means may further comprise an antenna arrangement or a plurality of antenna arrangements for generating the magnetic field for an energy supply of the portable electronic device by means of an inductive coupling from the generated magnetic field.

An antenna arrangement control means may be associated with the energy provisioning means, wherein the antenna arrangement control means is implemented, depending on the energy demand of the portable electronic device, to connect individual antenna arrangements of the plurality of antenna arrangements for energy supply to the energy provisioning means or disconnect them from the same.

The antenna arrangement control means may be implemented to determine the antenna arrangement of the plurality of antenna arrangements which comprises an increased degree of coupling to the portable electronic device at least as compared to one of the other antenna arrangements and which is further implemented to connect the antenna arrangement having the increased degree of coupling to the energy provisioning means for generating a magnetic field for an energy supply of the portable electronic device.

The optical, bidirectional data communication means may comprise an optical interface element or a plurality of optical interface elements for establishing a conductor-less, bidirectional, optical data communication with the portable electronic device.

A communication control means may be associated with the optical data communication means, wherein the communication control means is implemented, depending on the bandwidth requirement for the communication between the basic device and the portable electronic device, to activate or deactivate individual optical interface elements of the plurality of optical interface elements for the data transmission to the optical data transmission means.

The communication control means may be implemented to associate the data communication with the portable electronic device associated with an electronic functionality of the portable electronic device to an optical interface element of the plurality of optical interface elements.

The communication control means may be further implemented to determine the optical interface element of the plurality of optical interface elements which may set up an optical, conductor-less communication connection with the portable electronic device when coupling the basic device to a portable electronic device.

The optical interface element or the plurality of optical interface elements may be implemented to execute an optical, conductor-less data transmission in the infrared range.

According to a further aspect, the basic device may further comprise a fixing means for fixing and/or mounting the portable, electronic device in a given position, aligned for energy and data transmission, at the basic device.

The fixing means may further comprise mechanical and/or magnetic fixing elements.

According to a further aspect, the basic device may further comprise a port replicator for providing a plurality of data interfaces for a plurality of peripheral devices.

The port replicator may comprise a signal processing means and/or a multiplexor arrangement for a data connection to the plurality of peripheral devices via an interface.

According to a further aspect, the basic device may further comprise a control means for controlling the energy provisioning means and the data communication means.

According to another aspect, a portable, multimedia-capable terminal device comprises a functional means for providing an application or a service; an optical, bidirectional data transmission means for a conductor-less, optical data communication with an external basic device; and an energy supply means for energy absorption by means of an inductive coupling from a magnetic field emitted by the external basic device and for supplying the functional means and the data transmission means with energy based on the energy taken from the external magnetic field; wherein the energy supply means comprises a chargeable charge storage element and is further implemented to charge the chargeable charge storage element based on the energy taken from the external magnetic field.

The charge storage element may be implemented as a chargeable battery and wherein the energy supply means is implemented to supply the functional means with energy from the chargeable charge storage element when the portable electronic device is decoupled from the basic device.

According to another aspect, a portable data storage comprises a functional means with a non-volatile memory element for providing an electronic functionality in the form of storing data and providing stored data upon request; an optical, bidirectional data transmission means for a conductor-less, optical data communication with an external basic device; and an energy supply means for energy absorption by means of an inductive coupling from a magnetic field emitted by the external basic device and for supplying the functional means and the data transmission means with energy based on the energy taken from the external magnetic field; wherein the energy supply means comprises a chargeable charge storage element and is further implemented to charge the chargeable charge storage element based on the energy taken from the external magnetic field.

The charge storage element may be implemented as a chargeable capacitor storage in the form of a bridging or short-term energy storage, and wherein the energy supply means is implemented to supply the functional means with energy from the chargeable charge storage element when the portable electronic device is decoupled from the basic device.

The basic device may further be used for manufacturing a conductor-less energy and data transmission connection with the portable device.

The basic device may establish a data connection between a peripheral device coupled via an interface and the portable electronic device.

According to another aspect, a method for coupling a portable electronic device to an external basic device comprises determining a portable electronic device existing in a coupling area of the external basic device; establishing a conductor-less energy and data transmission between the portable electronic device and the external basic device.

The method may further comprise determining an antenna arrangement from a plurality of antenna arrangements of the portable electronic device comprising an increased degree of coupling to the magnetic field provided by the external basic device as compared to at least one of the other antenna arrangements, and switching in the antenna arrangement with the increased degree of coupling for energy absorption by means of an inductive coupling from the magnetic field provided by the external basic device.

The method may further comprise determining an optical interface element of a plurality of optical interface elements which may set up a conductor-less, optical communication connection with the external basic device when coupling the portable electronic device to the external basic device.

The method may further comprise determining an antenna arrangement from a plurality of antenna arrangements of the external basic device which comprises an increased degree of coupling with the portable electronic device at least compared to one of the other antenna arrangements, and switching in the antenna arrangement with the increased degree of coupling to the energy provisioning means for generating a magnetic field for an energy supply of the portable electronic device.

The method may further comprise determining an optical interface element from a plurality of optical interface elements of the external basic device which may set up an optical, conductor-less communication connection with the portable electronic device when coupling the basic device to a portable electronic device.

1. A portable electronic device, comprising:
a functional processor for providing an electronic functionality;
an optical data transmitter for a conductor-less, optical data communication with an external basic device, wherein the optical data transmitter comprises a plurality of optical interface elements for establishing a conductor-less, optical data transmission with the external basic device, and wherein a communication controller is associated with the optical data transmitter, wherein the communication controller is implemented to selectively allocate the data communication with an external basic device associated with an electronic functionality of the functional processor each to an optical interface element of the plurality of optical interface elements; and
an energy supplier for energy absorption by means of an inductive coupling from a magnetic field emitted from the external basic device and for supplying the functional processor and the data transmitter with energy based on the energy taken from the external magnetic field.

2. The portable electronic device according to claim 1, wherein the communication controller is implemented, depending on the bandwidth requirement for the communication between the portable electronic device and the external basic device, to activate a group of optical interface elements of the plurality of optical interface elements for a parallel data transmission.

3. The portable electronic device according to claim 1, wherein the energy supplier comprises a chargeable charge storage element and is further implemented to charge the chargeable charge storage element based on the energy taken from the external magnetic field.

4. The portable electronic device according to claim 3, wherein the energy supplier is implemented to supply the functional processor with energy from the chargeable charge storage element when the portable electronic device is decoupled from the basic device.

5. The portable electronic device according to claim 3, wherein the charge storage element is implemented as a chargeable battery or as a chargeable capacitor storage.

6. The portable electronic device according to claim 1, wherein the energy supplier comprises a communicator which is implemented to execute a data exchange of data relating to the energy transmission from the basis device, with the basic device.

7. The portable electronic device according to claim 6, wherein data relating to the energy transmission comprises control information for the basic device generating the external magnetic field for providing the external magnetic field.

8. The portable electronic device according to claim 6, wherein the communication unit is implemented to execute the data exchange of the data relating to the energy transmission by means of load modulation.

9. The portable electronic device according to claim 1, wherein the energy supplier comprises an antenna arrangement or a plurality of antenna arrangements for energy absorption by means of an inductive coupling from the magnetic field provided by the external basic device.

10. The portable electronic device according to claim 9, wherein a controller is associated with the energy supplier, wherein the controller is implemented, depending on the energy demand of the portable electronic device, to connect individual antenna arrangements of the plurality of antenna arrangements, for energy absorption, to the energy supplier or disconnect the same.

11. The portable electronic device according to claim 9, wherein the controller is implemented to determine the antenna arrangement of the plurality of antenna arrangements which comprises an increased degree of coupling with the magnetic field provided by the external basic device as compared to the other antenna arrangements and which is further implemented to connect the antenna arrangement comprising the increased degree of coupling to the energy supplier, for energy absorption by means of inductive coupling from the magnetic field provided by the external basic device.

12. The portable electronic device according to claim 9, wherein the plurality of antenna arrangements for energy absorption are arranged distributed at one or at several side surfaces of the portable electronic device.

13. The portable electronic device according to claim 1, wherein the communication controller is further implemented to determine the optical interface element of the plurality of optical interface elements which may set up a conductor-less, optical communication connection with the external basic device when coupling the portable electronic device to the external basic device.

14. The portable electronic device according to claim 1, wherein the plurality of optical interface elements are implemented to execute the conductor-less, optical data transmission to the external basic device in the infrared range.

15. The portable electronic device according to claim 1, which is implemented as a mobile telephone, notebook, tablet PC, E-Reader or digital camera, wherein the functional processor is implemented to execute an application or a service as an electronic functionality.

16. The portable electronic device according to claim 1, wherein the electronic functionality provided by the functional processor is an application or service.

17. The portable electronic device according to claim 1, implemented as a portable data storage, wherein the functional processor exclusively comprises a mass storage element to store data and provide the same upon request as an electronic functionality.

18. The portable electronic device according to claim 1, implemented as a telemonitoring device for monitoring persons or patients, wherein the functional processor is implemented to detect medical or physiological data of persons or patients as an electronic functionality and to evaluate the detected data or provide the detected data to the external basic device or to a peripheral device for evaluation connected to the same by an interface.

19. The portable electronic device according to claim 1, which is completely hermetically encapsulated with respect to gaseous or liquid environmental influences.

20. The portable electronic device according to claim 1, comprising further data interfaces and/or an interaction interface for an operator.

21. A basic device for energy and data transmission to a portable electronic device, comprising:
an energy provider for generating a magnetic field for an energy supply of the portable electronic device by means of an inductive coupling from the generated magnetic field; and
an optical, bidirectional data communicator for a conductor-less, optical data communication with the portable electronic device;
wherein the optical, bidirectional data communicator comprises a plurality of optical interface elements for establishing a conductor-less, bidirectional, optical data communication with the portable electronic device, and wherein a communication controller is associated with the optical data communicator, wherein the communication controller is implemented to selectively allocate the data communication with the portable electronic device associated with an electronic functionality of the portable electronic device each to an optical interface element of the plurality of optical interface elements.

22. The basic device according to claim 21, wherein the energy provider comprises a basic communicator which is implemented to execute a data exchange of data relating to energy transmission from the basic device to the portable electronic device with the portable electronic device.

23. The basic device according to claim 21, wherein the energy provider comprises an antenna arrangement or a plurality of antenna arrangements for generating the magnetic field for an energy supply of the portable electronic device by means of an inductive coupling from the generated magnetic field.

24. The basic device according to claim 23, wherein an antenna arrangement controller is associated with the energy provider, wherein the antenna arrangement controller is implemented, depending on the energy demand of the portable electronic device, to connect individual antenna arrangements of the plurality of antenna arrangements for energy supply to the energy provider or disconnect them from the same.

25. The basic device according to claim 23, wherein the antenna arrangement controller is implemented to determine the antenna arrangement of the plurality of antenna arrangements which comprises an increased degree of coupling to the portable electronic device at least as compared to one of the other antenna arrangements and which is further implemented to connect the antenna arrangement comprising the increased degree of coupling to the energy provider for generating a magnetic field for an energy supply of the portable electronic device.

26. The basic device according to claim 25, wherein the communication controller is implemented, depending on the bandwidth requirement for the communication between the basic device and the portable electronic device, to activate a group of optical interface elements of the plurality of optical interface elements for a parallel data transmission to the optical data transmitter.

27. The basic device according to claim 21, wherein the communication controller is further implemented to determine the optical interface element of the plurality of optical interface elements which may set up an optical, conductor-less communication connection with the portable electronic device when coupling the basic device to a portable electronic device.

28. The basic device according to claim 27, wherein the optical interface element or the plurality of optical interface elements are implemented to execute an optical, conductor-less data transmission in the infrared range.

29. The basic device according to claim 21, further comprising:
a fixator for fixing and/or mounting the portable, electronic device in a given position, aligned for energy and data transmission, at the basic device.

30. The basic device according to claim 32, wherein the fixator comprises mechanical and/or magnetic fixing elements.

31. The basic device according to claim 21, further comprising:
a port replicator for providing a plurality of data interfaces for a plurality of peripheral devices.

32. The basic device according to claim 31, wherein the port replicator comprises a signal processor and/or a multiplexor arrangement for a data connection to the plurality of peripheral devices via an interface.

33. The basic device according to claim 21, further comprising:
a controller for controlling the energy provider and the data communicator.

34. A portable data storage in the form of an external hard disk or a memory stick with a conductor-less energy supply and data communication, comprising:
a functional processor with a non-volatile memory element for providing an electronic functionality in the form of storing data and providing stored data upon request;
an optical, bidirectional data transmitter for a conductor-less, optical data communication with an external basic device; and
an energy supplier for energy absorption by means of an inductive coupling from a magnetic field emitted by the external basic device and for supplying the functional processor and the data transmitter with energy based on the energy taken from the external magnetic field;
wherein the energy supplier comprises a chargeable charge storage element and is further implemented to charge the chargeable charge storage element based on the energy taken from the external magnetic field.

35. The portable electronic data storage according to claim 34, wherein the charge storage element is implemented as a chargeable capacitor storage in the form of a bridging or short-term energy storage, and wherein the energy supplier is implemented to supply the functional processor with energy from the chargeable charge storage element when the portable electronic device is decoupled from the basic device.

36. The portable electronic data storage according to claim 34, wherein the data storage is implemented plugless.

37. A method for coupling a portable electronic device to an external basic device, wherein the optical data transmitter comprises a functional processor for providing a plurality of electronic functionalities and further a plurality of optical interface elements for establishing a conductor-less, optical data transmission with the external basic device, comprising:
determining a portable electronic device which is present in a coupling area of the external basic device;
establishing a conductor-less energy and data transmission between the portable electronic device and the external basic device; and
selectively allocating the data communication with the external basic device associated with an electronic functionality of the functional processor each to an optical interface element of the plurality of optical interface elements.

38. The method according to claim 37, further comprising:
activating a group of optical interface elements from the plurality of optical interface elements of the portable electronic device depending on the determined bandwidth requirement for a parallel data transmission between the portable electronic device and the external basic device.

39. The method according to claim 37, further comprising:
determining an antenna arrangement from a plurality of antenna arrangements of the portable electronic device comprising an increased degree of coupling to the magnetic field provided by the external basic device as compared to at least one of the other antenna arrangements, and
switching in the antenna arrangement with the increased degree of coupling for energy absorption by means of an inductive coupling from the magnetic field provided by the external basic device.

40. The method according to claim 37, further comprising:
determining an antenna arrangement from a plurality of antenna arrangements of the external basic device which comprises an increased degree of coupling with the portable electronic device at least compared to one of the other antenna arrangements, and
switching in the antenna arrangement with the increased degree of coupling to the energy provider for generating a magnetic field for an energy supply of the portable electronic device.
